(19) United States
(12) Patent Application Publication
(10) Pub. No.: US 2025/0078468 A1
(43) Pub. Date: Mar. 6, 2025

(54) DEVICE AND COMPUTER-IMPLEMENTED METHOD FOR MACHINE LEARNING

(71) Applicant: Robert Bosch GmbH, Stuttgart (DE)

(72) Inventors: Michael Pritz, Wien (AT); Daria Stepanova, Leonberg (DE); Johannes Oetsch, Wien (AT); Nelson Higuera, Wien (AT); Nicole Ying Finnie, Renningen (DE); Thomas Eiter, Wien (AT)

(21) Appl. No.: 18/799,041

(22) Filed: Aug. 9, 2024

(30) Foreign Application Priority Data
Sep. 6, 2023 (DE) 10 2023 208 618.2

(51) Int. Cl. G06V 10/764; G06V 10/776; G06V 20/70

(52) U.S. Cl. CPC G06V 10/765; G06V 10/776; G06V 20/70

(57) ABSTRACT

A device and computer-implemented method for machine learning. The method includes: providing first and second classes; providing a first set of scene graphs including scene graphs of digital images that are incorrectly classified in the first class or the second class; providing a second set of scene graphs including scene graphs of digital images that are correctly classified with respect to the first class or the second class; determining, depending on the first set of scene graphs and the second set of scene graphs a rule that indicates that a presence of a first object and/or a second object in a digital image and/or a relation between the first object and the second object in the scene graph of the digital image results in that the classification of the digital image includes a misclassification of the digital image into the second class instead of the first class.

### CROSS REFERENCE

The present application claims the benefit under 35 U.S.C. § 119 of German Patent Application No. DE 10 2023 208 618.2 filed on Sep. 6, 2023, which is expressly incorporated herein by reference in its entirety.

### FIELD

The present invention relates to a device and a computer-implemented method for machine learning.

### BACKGROUND INFORMATION

In machine learning, classifiers may be used to classify digital images.

### SUMMARY

A device and the computer-implemented method according to the present invention provide a rule to identify whether a classifier makes systematic mistakes. The rule may assist in providing means for improving the classifier.

According to an example embodiment of the present invention, the method comprises providing a first class and a second class of a classification, providing a first set of scene graphs, wherein the first set of scene graphs comprises scene graphs of digital images that are incorrectly classified in the first class or the second class, providing a second set of scene graphs, wherein the second set of scene graphs comprises scene graphs of digital images that are correctly classified with respect to the first class or the second class, determining, depending on the first set of scene graphs and the second set of scene graphs a rule that indicates that a presence of a first object and/or a second object in a digital image and/or a relation between the first object and the second object in the scene graph of the digital image results in that the classification of the digital image comprises a misclassification of the digital image into the second class instead of the first class.

According to an example embodiment of the present invention, the digital image may be captured by a sensor, in particular a camera, a radar sensor, a lidar sensor, an infrared sensor, an ultrasound sensor or a motion sensor.

According to an example embodiment of the present invention, the method may comprise detecting an anomaly depending on the rule, or determining a cause of an anomaly depending on the rule. For example, the anomaly is detected depending on the rule, in case the rule indicates the misclassification and no anomaly is detected depending on the rule otherwise.

According to an example embodiment of the present invention, the method may comprise operating a technical system, particular a system for conveying information, in particular a surveillance system or a medical imaging system, depending on the classification, and operating the technical system independent of the classification in case an anomaly is detected depending on the rule.

According to an example embodiment of the present invention, operating the technical system may comprise outputting an output, in particular a control signal for controlling the technical system, or a display of the classification for displaying by the technical system, that is determined depending on the classification in case no anomaly is detected and not outputting the output, or outputting the output with an indication that the anomaly is detected in case the anomaly is detected.

According to an example embodiment of the present invention, the method may comprise determining a logic program depending on the first set of scene graphs and the second set of scene graphs, and determining the rule depending on the logic program.

According to an example embodiment of the present invention, the method may comprise providing a label for at least one digital image, determining a classification for the at least one digital image depending on at least a part of the at least one digital image, in particular pixel values of the at least one digital image, determining a scene graph for the at least one digital image depending on at least a part of the at least one digital image, in particular pixel values of the at least one digital image, determining depending on the label and the classification of the at least one digital image whether the classification of the at least one digital image is correct or not, and adding the scene graph for the at least one digital image to the first set of scene graphs in case the classification is incorrect, or adding the scene graph for the at least one digital image to the second set of scene graphs in case the classification is correct. This means, the scene graphs are split into two sets.

According to an example embodiment of the present invention, the device comprises at least one processor and at least one memory, wherein the at least one processor is configured to execute instructions that, when executed by the at least one processor cause the device to execute the method, and wherein the at least one memory is configured to store the instructions.

A computer program of the present invention may comprise computer-readable instructions that, when executed by the computer, cause the computer to execute the method of the present invention.

Further advantageous embodiments of the present invention are derived from the following description and the figures.

### BRIEF DESCRIPTION OF THE DRAWINGS

FIG. 1 schematically depicts a device for machine learning, according to an example embodiment of the present invention.

FIG. 2 depicts a flowchart of a computer implemented method for machine learning, according to an example embodiment of the present invention.

FIG. 3 schematically depicts an exemplary misclassification for images 302.

FIG. 4 schematically depicts a scene graph for a first digital image, according to an example embodiment of the present invention.

FIG. 5 schematically depicts a scene graph for a second digital image, according to an example embodiment of the present invention.

### DETAILED DESCRIPTION OF EXAMPLE EMBODIMENTS

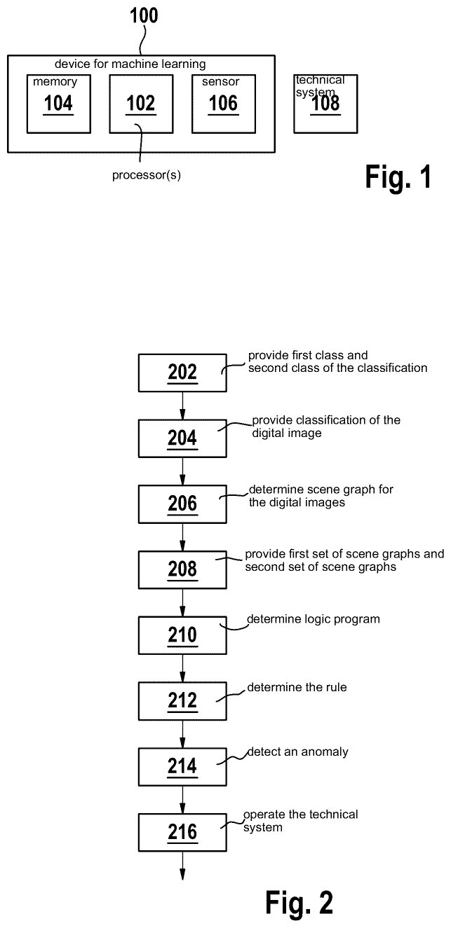

FIG. 1 schematically depicts a device 100 for machine learning. The device 100 comprises at least one processor 102 and at least one memory 104.

The at least one processor 102 is configured to execute instructions that, when executed by the at least one processor 102 cause the device 100 to execute a in particular computer implemented method for machine learning. The at least one memory 104 is configured to store the instructions. The instructions may be computer-readable instructions.

The device 100 optionally comprises a sensor 106. The sensor 106 is for example a camera, a radar sensor, a lidar sensor, an infrared sensor, an ultrasound sensor or a motion sensor.

The device 100 is configured to determine a classification depending on the digital image. The device 100 optionally is configured to control a technical system 108 depending on the classification.

The technical system 108 may be a system for conveying information, in particular a surveillance system or a medical imaging system. The technical system 108 may comprise the sensor 106 instead of the device 100. The technical system 108 may comprise the device 100.

The device 100 optionally is configured to provide the classification to an output. The device 100 is configured to determine a rule depending on the digital image. The device 100 optionally is configured to detect an anomaly and/or to determine a cause of an anomaly depending on the rule.

A computer program may the comprise computer-readable instructions.

The device 100 comprises a classifier that is configured to output a classification of a digital image depending on at least a part of the digital image, in particular pixel values of the digital image.

The device 100 comprises a model that is configured to construct scene graphs comprising objects and relations between objects in the digital image that are detected by the model depending on a digital image. The device 100 comprises a reasoner that is configured to determine rules depending on a logic program. The device 100 is configured to execute a method for machine learning to determine the logic program and the rules depending on digital images.

The logic program comprise a set of rules. A rule is an if-then expression, whose if-part may contain several conditions, some possibly with negation. The then-part has a single atom that has to hold, whenever the if-part holds.

A rule r is an expression of the form

$$h ( X ) ← {b}_{1} ( {y}_{1} ) , … , {b}_{k} ( {Y}_{k} ) , not {b}_{k + 1} ( {Y}_{k + 1} ) , … , not {b}_{n} ( {Y}_{n} )$$

where h(x), b₁(Y₁), . . . , bₙ (Yₙ) are first-order atoms. The right-hand side of the rule r is a conjunction of atoms. Moreover, X, Y₁, . . . , Yₙ are tuples of either variables or constants whose length corresponds to the arity of the predicates h, b₁, . . . , bₙ respectively. The left-hand side of the rule r is referred to as its head, denoted by head(r), while the right-hand side is its body denoted body(r). The positive and negative parts of the body are respectively denoted as body⁺(r) and body⁻(r).

The rule r is positive, if body⁻(r)=Ø and negative otherwise.

The following rule r states, that the classifier tends to classify a digital image in a first class₁ instead of a second class c₂:

$$r : misclassifies ( id 1 , {c}_{1} , {c}_{2} ) ← includes ( id 1 , id 2 ) , person ( id 2 ) , dog ( id 3 ) , includes ( id 1 , id 3 ) , walking ( id 2 , id 3 )$$

wherein id2, id3 are identifiers of concrete objects in a scene id1 that is depicted in the digital image and wherein includes, person, and walking are relations.

The rule r indicates that a presence of a first object id2 and/or a second object id3 in a digital image, i.e., the scene id1, and/or a relation, e.g. walking, between the first object id2 and the second object id3 in the scene graph of the digital image results in that the classification of the digital image comprises a misclassification of the digital image into the second class c₂ instead of the first class c₁.

The rule r is determined with inductive logic programming. Inductive logic programming is described e.g., in Zeng et al. 2014: Qiang Zeng, Jignesh M. Patel, and David Page. Quickfoil: Scalable inductive logic programming. Proc. VLDB Endow., 8 (3):197-208, 2014.

The goal of Inductive Logic Programming, is to generalize individual instances or observations in presence of background knowledge by building hypotheses about yet unseen instances. Inductive logic programming is used for learning the rule r that distinguishes wrongly classified scenes from the correctly classified ones.

FIG. 2 depicts a flowchart of the method for machine learning.

A goal of the method is to detect systematic mistakes in a pre-trained classifier f:(Ω→ [symbol] ³)→C. The input for the method is the classifier f, a labeled data set D={(iₖ, cₖ)}ₖ₌₁ⁿ with n samples of a scene image i∈I from a set of scene images I and a label c∈C from a set of classes C, and the first class c₁ and the second class c₂ with c₁≠c₂, c₁∈C, c₂∈C.

The classification may be a scene classification. Assuming a set of object classes C for a given scene image I:Ω→ [symbol] ³, where Ω denotes the pixel space, the scene classification is concerned with the construction of a classifier. The classifier is for example a convolutional neural network with L layers according to a function f:(Ω→ [symbol] ³)→C, namely f(I)=argmax_{k∈C}(softmax(fₗ∘ . . . ∘f₂∘f₁(I))ₖ) where fₗ defines the l^{th} layer of the network.

The method comprises a step 202.

The step 202 comprises providing the first class c₁ and the second class c₂ of the classification.

The step 202 comprises providing pairs (iₖ, cₖ) of a digital image iₖ and a label cₖ that indicates at least one correct class of the classification for the digital image iₖ.

According to an example, the pairs (iₖ, cₖ) are provided from a storage comprising the pairs (iₖ, cₖ).

The step 202 optionally comprises capturing the respective digital image. The step 202 optionally comprises labelling the respective digital image.

The respective digital image is for example captured by the sensor 106.

The method comprises a step 204.

The step 204 comprises providing classifications of the digital images. According to an example, the classifications of the digital images are provided with the classifier:

$$f : ( Ω \to {3}^{} ) \to C$$

The classification f(iₖ) of a respective digital image iₖ is provided depending on the respective digital image iₖ, in particular pixel values of the respective digital image iₖ.

The method comprises a step 206.

The step 206 comprises determining a scene graph Gᵢ for the digital images i. According to an example, the scene graphs Gᵢ of the digital images i are provided with the model. The scene graph Gᵢ_{ₖ} of a respective digital image iₖ is provided depending on the respective digital image iₖ, in particular pixel values of the respective digital image iₖ.

The method comprises a step 208.

The step 208 comprises providing a first set of scene graphs E_{G}⁺ and a second set of scene graphs E_{G}⁻. The first set of scene graphs E_{G}⁺ and the second set of scene graphs E_{G}⁻ may be read from a storage comprising a predetermined first set of scene graphs E_{G}⁺ and a predetermined second set of scene graphs E_{G}⁻. In case the predetermined first set of scene graphs E_{G}⁺ and the predetermined second set of scene graphs E_{G}⁻ is available, the steps 202 to 206 may be omitted, i.e., the method may start with step 208.

The first set of scene graphs E_{G}⁺ comprises scene graphs Gᵢ of digital images i that are incorrectly classified by the classifier. Incorrectly classified may mean that the classification f(iₖ) of a respective digital image iₖ fails to match the label cₖ provided for the respective digital image iₖ.

The second set of scene graphs E_{G}⁻ comprises scene graphs Gᵢ of digital images i that are correctly classified by the classifier. Correctly classified may mean that the classification f(iₖ) of a respective digital image iₖ matches the label cₖ provided for the respective digital image iₖ.

According to an example, it is determined depending on the label cₖ provided for a respective digital image iₖ and the classification f(iₖ) of the respective digital image iₖ whether the classification f(iₖ) of the respective digital image iₖ is incorrect or correct.

In case the classification f(iₖ) of the respective digital image iₖ is incorrect, i.e., fails to match the label cₖ provided for the respective digital image iₖ, the scene graph for the respective digital image iₖ is added to the first set of scene graphs E_{G}⁺.

In case the classification f(iₖ) of the respective digital image iₖ is correct, i.e., matches the label cₖ provided for the respective digital image iₖ, the scene graph for the respective digital image iₖ is added to the second set of scene graphs E_{G}⁻.

According to an example, a classifier-based scene splitting comprises collecting wrongly and correctly classified digital images i that are labelled as images of the first class c₁ into the following two sets respectively:

$${E}^{+} = \{ i ∈ I \vert f ( i ) = {c}_{1} , ( i , {c}_{2} ) ∈ D \}$$

$${E}^{-} = \{ i ∈ I \vert f ( i ) = {c}_{1} , ( i , {c}_{1} ) ∈ D \}$$

According to an example the scene graph construction comprises constructing the first set of scene graphs E_{G}⁺ for the digital images from the set E⁺ and constructing the second set of scene graphs E_{G}⁻ for the digital images from the set E⁻

The method comprises a step 210.

The step 210 comprises determining the logic program depending on the first set of scene graphs and the second set of scene graphs.

In the example, an inductive logic programming problem instance is formulated as follows by translating the scene graphs Gᵢ to their respective representation as binary ground predicates. Optionally, formulating the inductive logic programming may consider background knowledge B available, describing further semantic information regarding object classes appearing in the scene. The background knowledge B may comprise unary and binary ground predicates constructed from the scene graphs Gᵢ.

The method comprises a step 212.

The step 212 comprises determining the rule r depending on the first set of scene graphs E_{G}⁺ and the second set of scene graphs E_{G}⁻.

The rule r is determined depending on the logic program.

According to an example, the rule r is determined with the reasoner that reasons on the logic program. In the example, an inductive logic programming reasoner reasons on the inductive logic programming program. Zeng et al. 2014 describes an exemplary inductive logic programming reasoner that may be used to determine the rule r.

The method may comprise a step 214.

The step 214 comprises detecting an anomaly depending on the rule, or determining a cause of an anomaly depending on the rule.

The method may comprise a step 216.

The step 216 comprises operating the technical system 108.

According to an example, the technical system 108 is operated depending on the classification in case no anomaly is detected.

According to an example, the technical system 108 is operated independent of the classification in case an anomaly is detected depending on the rule.

Operating the technical system 108 for example comprises outputting an output in case no anomaly is detected depending on the rule.

Operating the technical system 108 for example comprises not outputting the output in case an anomaly is detected depending on the rule.

The method may comprise outputting the output with an indication that the anomaly is detected in case the anomaly is detected.

The output is for example a control signal for controlling the technical system 108. The output is for example a display of the classification for displaying by the technical system 108.

The output is for example determined depending on the classification.

The method is described by way of example of a rule r. Multiple rules may be determined with the reasoner as a result of reasoning on the logic program.

The rule r identifies a pattern in the data D that the classifier f wrongly classified into the second class c₂.

An example for an application of the method to identify the pattern in an input comprising five digital images is provided below.

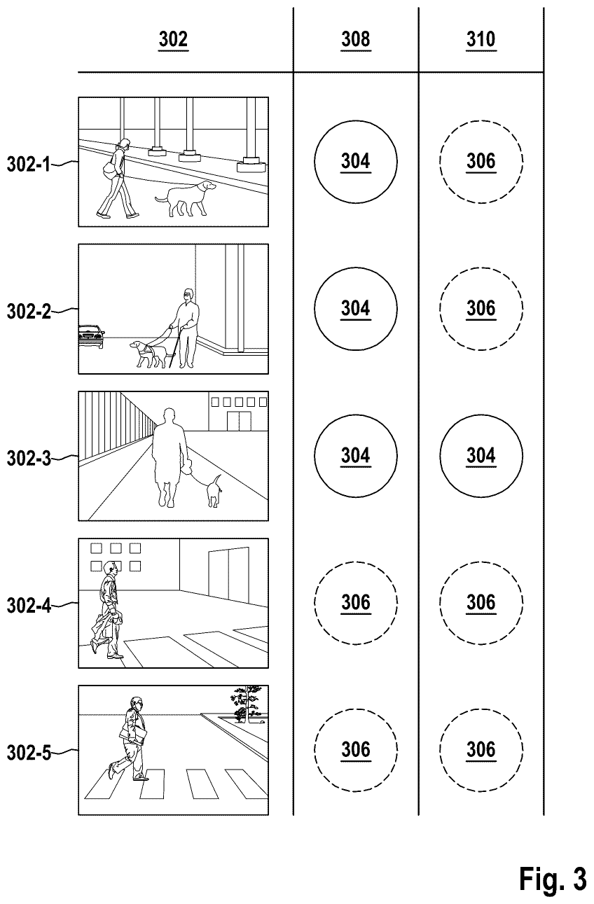

FIG. 3 schematically depicts an exemplary misclassification for images 302 in an exemplary first class 304 and an exemplary second class 306. A predicted class 308 of a first digital image 302-1 is the first class 304. A label 310 for the first digital image 302-1 is the second class 306. This means, the first digital image 302-1 is misclassified. The predicted class 308 of a second digital image 302-2 is the first class 304. The label 310 for the second digital image 302-2 is the second class 306. This means, the second digital image 302-2 is misclassified. The predicted class 308 of a third digital image 302-3 is the first class 304. The label 310 for the third digital image 302-3 is the first class 304. This means, the third digital image 302-3 is classified correctly. The predicted class 308 of a fourth digital image 302-4 is the second class 306. The label 310 for the fourth digital image 302-4 is the second class 306. This means, the fourth digital image 302-4 is classified correctly. The predicted class 308 of a fifth digital image 302-5 is the second class 306. The label 310 for the fifth digital image 302-5 is the second class 306. This means, the fifth digital image 302-5 is classified correctly.

For example, the first image 302-1 and the second image 302-2 were misclassified. The method systematically analyzes the misclassification mistakes using rule induction.

The scene graph is a structured representation of a scene that expresses objects, attributes, and relations among objects in the scene. The scene graph may be determined by the model according to a method for constructing scene graphs e.g., as described in Zhu et al. 2022. Guangming Zhu, Liang Zhang, Youliang Jiang, Yixuan Dang, Haoran Hou, Peiyi Shen, Mingtao Feng, Xia Zhao, Qiguang Miao, Syed Afaq Ali Shah, and Mohammed Bennamoun. Scene graph generation: A comprehensive survey. CORR, abs/2201.00443, 2022.

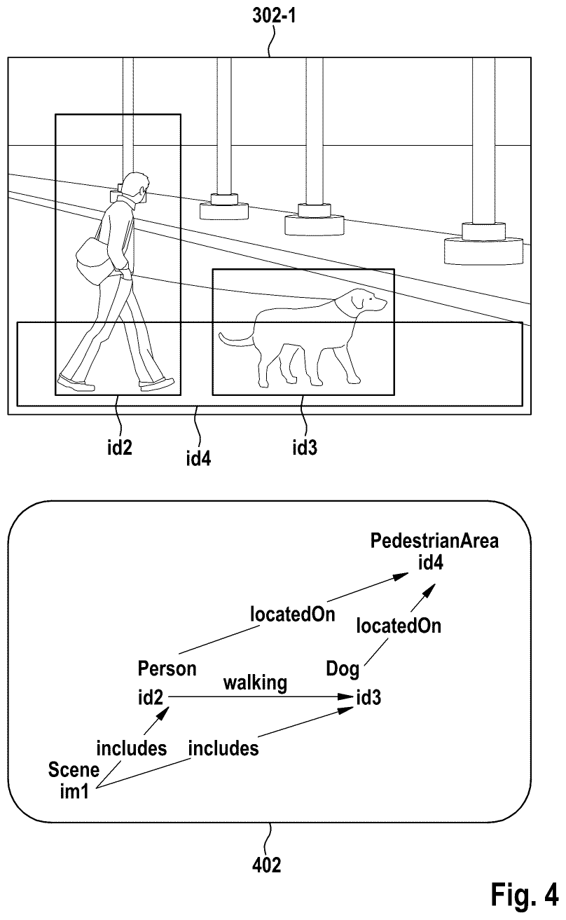

FIG. 4 schematically depicts an exemplary scene graph 402 for a scene represented in the first digital image 302-1. The first digital image 302-1 comprises a scene im1 that is associated with an attribute “Scene” in the scene graph 402. The first digital image 302-1 comprises a first bounding box id2 that comprises a person and is associated with an attribute “Person” in the scene graph 402. The first digital image 302-1 comprises a second bounding box id3 that comprises a dog and is associated with an attribute “Dog” in the scene graph 402. The first digital image 302-1 comprises a third bounding box id4 that comprises a pedestrian area and is associated with an attribute “PedestrianArea” in the scene graph 402. The scene graph 402 comprises a relation “includes” between the attribute “Scene” or the scene im1 and the attribute “Person” or the first bounding box id2. The scene graph 402 comprises a relation “includes” between the attribute “Scene” or the scene im1 and the attribute “Dog” or the second bounding box id3. The scene graph 402 comprises a relation “locatedOn” between the attribute “Person” or the first bounding box id2 and the attribute “PedestrianArea” or the third bounding box id4. The scene graph 402 comprises a relation “locatedOn” between the attribute “Dog” or the second bounding box id3 and the attribute “PedestrianArea” or the third bounding box id4. The scene graph 402 comprises a relation “walking” between the attribute “Person” or the first bounding box id2 and the attribute “Dog” or the second bounding box id3. The attribute “Person” represents a first object in the scene graph 402. The attribute “Dog” represents a second object in the scene graph 402. The relation “walking” represents a relation between the first object and the second object in the scene graph 402.

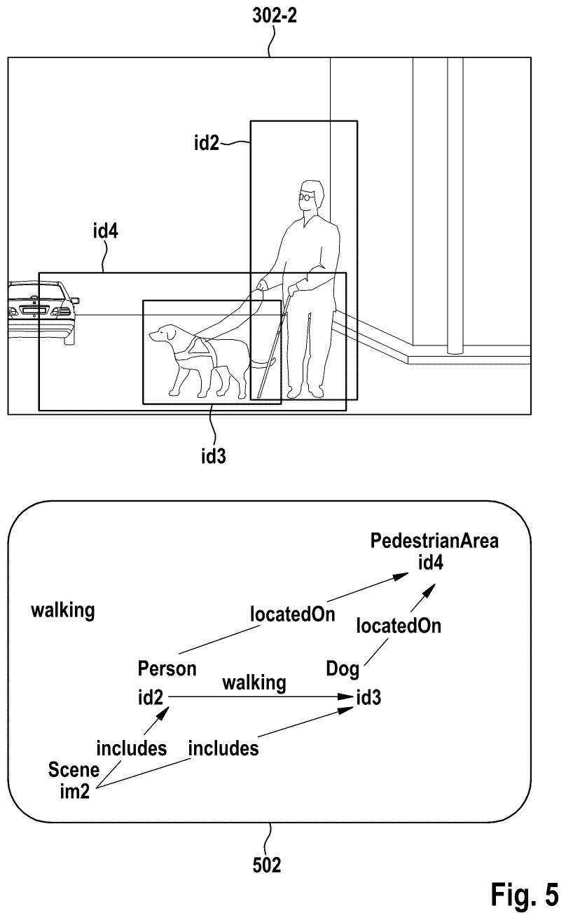

FIG. 5 schematically depicts an exemplary scene graph 502 for the second digital image 302-2. The second digital image 302-2 comprises a scene im2 that is associated with an attribute “Scene” in the scene graph 502. The scene graph 502 comprises the same entries as the scene graph 402. The attribute “Dog” represents a second object in the scene graph 502. The relation “walking” represents a relation between the first object and the second object in the scene graph 502.

Based on this input, the first set of scene graphs E⁺ comprises the first digital image 302-1 and the second set of scene graphs E⁻ comprises the third digital image 302-3.

The instance of the inductive logic programming in this example is

$${E}^{+} = \{ misc lassifies ( {im}_{1} , {c}_{1} , {c}_{2} ) , scene ( {im}_{2} ) \}$$

$${E}^{-} = \{ misc lassifies ( {im}_{3} , {c}_{1} , {c}_{2} ) , misclassifies ( {im}_{4} , {c}_{1} , {c}_{2} ) \}$$

wherein im₁ represents the first digital image 302-1, im₂ represents the second digital image 302-2, im₃ represents the third digital image 302-3, im₄ represents the fourth digital image 302-4, c₁ represents the first class 304, c₂ represents the second class 306.

The background knowledge B may comprise the unary and binary ground predicates constructed from the scene graphs of the five digital images.

The inductive logic programming used to extract rules r such that

$$r ⋃ ⊨ {E}_{G}^{+}$$

$$r ⋃ {E}_{G}^{+}$$

In the example, this results in the rule

$$r : misclassifies ( X , {c}_{1} , {c}_{2} ) ← includes ( X , Y ) , person ( Y ) , dog ( Z ) , includes ( X , Z ) , walking ( Y , Z )$$

wherein Y,Z identifiers of concrete objects in a scene X that is depicted in an input digital image and wherein includes, person, dog, and walking are relations.

For example, the anomaly is detected depending on the rule r, in case the rule r indicates for the input digital image the misclassification and no anomaly is detected depending on the rule r otherwise.

The misclassification or anomaly may be detected depending on the rule r in scene classifications, e.g., for autonomous driving or robotics. More generally, the method applies to detecting misclassification or anomaly in the task of classifying images of scenes to a set of predefined classes. For example, in the context of autonomous driving, scenarios in which a target vehicle is expected to stop, are distinguished from those scenarios, in which the target vehicle is allowed to continue driving. In robotics, e.g., images depicting combinations of objects that form a stable structure may be classified versus combinations, that likely fall apart, e.g., a glass on a table versus a glass on top of a ball. A digital image for that a misclassification or anomaly is detected or the classification determined depending on such digital image may not be used for decision making in autonomous driving or in robotics.

What is claimed is:

1. A computer-implemented method for machine learning, comprising the following steps:
providing a first class and a second class of a classification;
providing a first set of scene graphs, wherein the first set of scene graphs includes scene graphs of digital images that are incorrectly classified in the first class or the second class;
providing a second set of scene graphs, wherein the second set of scene graphs includes scene graphs of digital images that are correctly classified with respect to the first class or the second class; and
determining, depending on the first set of scene graphs and the second set of scene graphs, a rule that indicates that: (i) a presence of a first object and/or a second object in a digital image, and/or (ii) a relation between the first object and the second object in a scene graph of the digital image, results in that a classification of the digital image includes a misclassification of the digital image into the second class instead of the first class.

2. The method according to claim 1, wherein the digital image is captured by a sensor, including a camera, or a radar sensor, or a lidar sensor, or an infrared sensor, or an ultrasound sensor, or a motion sensor.

3. The method according to claim 1, further comprising: (i) detecting an anomaly depending on the rule, or (ii) determining a cause of an anomaly depending on the rule.

4. The method according to claim 3, further comprising:
operating a technical system depending on the classification; and
operating the technical system independent of the classification in case an anomaly is detected depending on the rule;
wherein the technical system includes a surveillance system or a medical imaging system.

5. The method according to claim 4, wherein the operating of the technical system includes:
when no anomaly is detected, outputting an output including a control signal for controlling the technical system, or a display of the classification for displaying by the technical system, the output being determined depending on the classification; and
when the anomaly is detected, not outputting the output, or outputting the output with an indication that the anomaly is detected.

6. The method according to claim 1, wherein the method further comprises determining a logic program depending on the first set of scene graphs and the second set of scene graphs, and determining the rule depending on the logic program.

7. The method according to claim 1, wherein the method further comprises:
providing a label for at least one digital image;
determining a classification for the at least one digital image, depending on at least a part of the at least one digital image including pixel values of the at least one digital image;
determining a scene graph for the at least one digital image, depending on at least a part of the at least one digital image including pixel values of the at least one digital image;
determining, depending on the label and the classification of the at least one digital image, whether the classification of the at least one digital image is correct or not; and
adding the scene graph for the at least one digital image to the first set of scene graphs when the classification is incorrect, or adding the scene graph for the at least one digital image to the second set of scene graphs when the classification is correct.

8. A device for machine learning, comprising:
at least one processor; and
at least one memory;
wherein the at least one processor is configured to execute instructions which, when executed by the at least one processor, cause the at least one processor to perform the following steps:
providing a first class and a second class of a classification,
providing a first set of scene graphs, wherein the first set of scene graphs includes scene graphs of digital images that are incorrectly classified in the first class or the second class,
providing a second set of scene graphs, wherein the second set of scene graphs includes scene graphs of digital images that are correctly classified with respect to the first class or the second class,
determining, depending on the first set of scene graphs and the second set of scene graphs, a rule that indicates that: (i) a presence of a first object and/or a second object in a digital image, and/or (ii) a relation between the first object and the second object in a scene graph of the digital image, results in that a classification of the digital image includes a misclassification of the digital image into the second class instead of the first class; and
wherein the at least one memory is configured to store the instructions.

9. A computer-readable medium on which is stored a computer program including computer-readable instructions for machine learning, the instructions, when executed by a computer, causing the computer to perform the following steps:
providing a first class and a second class of a classification;
providing a first set of scene graphs, wherein the first set of scene graphs includes scene graphs of digital images that are incorrectly classified in the first class or the second class;
providing a second set of scene graphs, wherein the second set of scene graphs includes scene graphs of digital images that are correctly classified with respect to the first class or the second class; and
determining, depending on the first set of scene graphs and the second set of scene graphs, a rule that indicates that: (i) a presence of a first object and/or a second object in a digital image, and/or (ii) a relation between the first object and the second object in a scene graph of the digital image, results in that a classification of the digital image includes a misclassification of the digital image into the second class instead of the first class.
